(19) United States
(12) Patent Application Publication
(10) Pub. No.: US 2008/0257171 A1
(43) Pub. Date: Oct. 23, 2008

(54) Toaster

(76) Inventor: Dong-lei Wang, Guangdong Province (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/816,373

(22) PCT Filed: Feb. 17, 2006
(86) PCT No.: PCT/CN06/00231

§ 371 Date: Aug. 15, 2007

(30) Foreign Application Priority Data
Feb. 19, 2005 (CN) 200520054963.6

(51) Int. Cl. A47J 37/08

(52) U.S. Cl. 99/389

(57) ABSTRACT

The present invention relates to an electric toaster comprising an outer housing, heating elements, and at least two bread toasting chambers, which are used to hold bread to toast. The heating elements are all tubular heating elements disposed on both sides of the toasting chambers. The electric toaster comprises at least one reflector, which is disposed inside the toasting region having a shape suitable for concentrating all the heat from the heating elements onto the bread-toasting chamber. The present invention can apply to electric toasters with two or more chambers with tubular heating elements, which enables bread to toast fast and safely by the use of high heating efficiency elements, such as quartz heating tubes or halogen heating tubes, etc.

### TECHNICAL FIELD

The present invention relates to a high power electric toaster having two or more toasting chambers, and in particular to an electric toaster with tubular heating elements with heat reflectors eliminating the need for heat shields.

### BACKGROUND OF THE INVENTION

At present, electric toasters, which are being sold in domestic and foreign markets, are mainly used for toasting pieces of food, such as bread, bagels and muffins, etc., and include a sheet heating element formed mainly by a mica sheet coiled by electric heating wires. In use, cooked pieces of food are put vertically into toasting chambers, and the sheet heating element is disposed parallel to the cooked pieces of food. Because thermal radiation is sent from the entire sheet heating element to the toasted food, even toasting is more easily achieved. However, the disadvantage of using a sheet-heating element is that, the power is confined to the coiled electric conductor, whereby the sheet heating element is slow to heat up, and high power toasting is difficult to achieve. Another implementation is to replace the sheet-heating element by a tubular heating element or use both of them together. But the available electric toasters, which adopt tubular heating elements as heating elements, have only one toasting chamber to toast food. The reasons lie in that, for electric toasters having two or more toasting chambers, if purely tubular heating elements are adopted, it is difficult to get the food evenly toasted by the middle heating tubes; while if both tubular and sheet heating elements are adopted, the structure of that electric toaster will be complicated and the toasting speed will remain slow. U.S. Pat. No. 5,400,697 issued Mar. 28, 1995 to Dax et al discloses a two toasting chamber electric toaster with four tubular heating elements. In the Dax et al toaster, in order to toast evenly, shielding bars were placed outside the heating tube towards the side of bread to avoid uneven toasting. Unfortunately, the arrangement of shielding bars inevitably results in low toasting efficiency and more toasting time. Therefore, fast toasting with high power cannot be achieved with prior art electric toasters.

### SUMMARY OF THE INVENTION

The invention is aimed at providing a kind of high power electric toaster with two or more bread toasting chambers, and to toast food evenly and fast without the use of shields.

The goal of the present invention is achieved by the following technical scheme:

an electric toaster comprising:

an outer housing with openings in the top;

a top cover;

a control device disposed on the outer housing;

a toasting region enclosed inside the outer housing comprising left and right toasting chambers for toasting slices of food, each toasting chamber having an opening, which conforms to one of the openings in the top of the outer housing, the toasting region is surrounded by a front plate, a back plate, a right and a left reflector, which are joined together;

upper, lower, left and right tubular heating elements disposed on both sides of the left and right toasting chambers; and

a bottom with the toasting region fixed thereto;

wherein a vertical plane which is parallel to a surface of the slices of food and which is in between the left and right toasting chambers is defined as a first central plane;

wherein the upper and lower tubular heating elements are disposed between the left and right toasting chambers, and central lines of the upper and lower tubular heating elements are both within the toasting region of the first central plane;

wherein a horizontal plane between of the upper and lower heating elements is defined as the second central plane;

wherein the left tubular heating element is disposed on a left side of the left toasting chamber, while the right tubular heating element is disposed on a right side of the right toasting chamber;

wherein central lines of said left and right tubular heating elements are within said second central plane;

wherein a horizontal distance from the left or right tubular heating element to the first central plane is equal;

wherein a left reflector is disposed on the left side of the left tubular heating element, while a right reflector is disposed on the right side of the right tubular heating element; the left reflector and the right reflector are symmetrical and inwardly concave;

wherein the left and right reflectors are defined by a plurality of surfaces at obtuse angles to each other; the shape of the left and right reflectors are suitable for reflecting part of the thermal radiation from the left and right heating elements toward the surface of the bread slice;

wherein each of said left and right reflectors contains a first reflective surface and a second reflective surface adjacent to each other which are located above the second central plane, and contains a third reflective surface and a fourth reflective surface also adjacent to each other which are located under the second central plane;

wherein the first reflective surface is disposed to the vertical plane at an angle α1 of 150° to 165°, and the second reflective surface is disposed to the first reflective surface at an angle α2 of 150° to 165°; and

wherein the third reflective surface and the first reflective surface, and the fourth reflective surface and the second reflective surface are symmetrical to the second central plane.

The present invention has the following advantages: the electric toaster has more heating tubes conforming to the shape of reflectors so as to toast food without shielding. Moreover, by the use of high efficiency heating elements, such as quartz heating tubes or halogen heating tubes etc, the electric toaster can toast bread slice faster and more safely. The power of the electric toaster can be increased to 1400 W, and food can be deeply toasted in a minute, which makes the toasting time three times faster than conventional electric toaster having mica heating elements coiled by electric heating wires.

### BRIEF DESCRIPTION OF THE DRAWINGS

FIG. 1 is a cross-sectional view of the electric toaster according to one embodiment of the present invention.

FIG. 2 is a cross-sectional view of a side reflector of the electric toaster as shown in FIG. 1.

### DETAILED DESCRIPTION OF THE PREFERRED EMBODIMENT

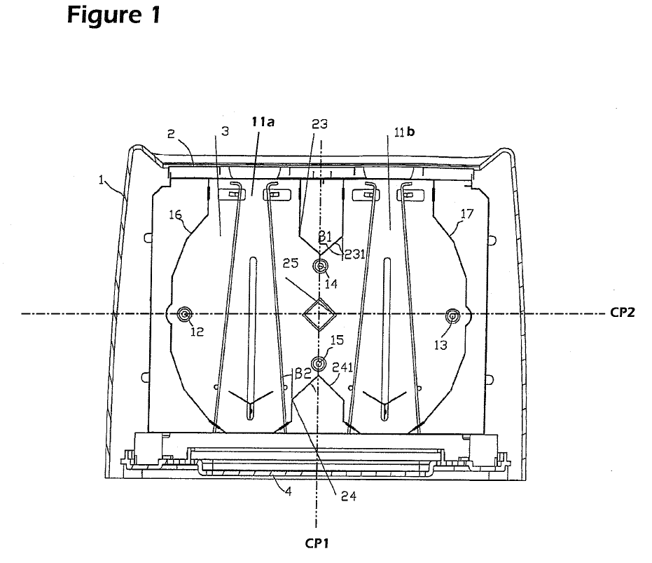

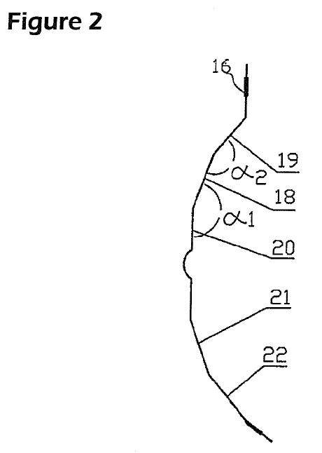

The electric toaster according to the present invention comprises at least two bread-toasting chambers and at least four tubular heating elements. As illustrated in FIGS. 1 and 2, the electric toaster with two bread toasting chambers and four tubular heating elements has high power for fast toasting, without requiring the prior art shielding bars, so as to achieve no-shielding toasting with increased heating efficiency and less toasting time.

The electric toaster according to the present invention comprises an outer housing 1 with openings in the top, a top cover 2, a control device disposed on the outer housing 1, a toasting region 3 and a bottom 4. The toasting region 3, enclosed inside the outer housing 1, comprises two toasting chambers 11a and 11b for toasting pieces, e.g. slices, of food. Each toasting chamber 11a and 11b has an opening in the top, which conforms to the openings in the top of the outer housing 1. Heating elements 12 to 15 are disposed on both sides of the toasting chambers 11a and 11b, which are all tubular heating elements. The toasting region 3 is surrounded by a front plate, a back plate (not shown), a right reflector 17 and a left reflector 16, which are joined together. The toasting region 3 is fixed on the bottom 4. A vertical plane, which is parallel to the surface of the food slice and which is in between of the two toasting chambers 11a and 11b, is defined as the first central plane CP1. Upper and lower tubular heating elements 14 and 15 are disposed between the toasting chambers 11a and 11b. The central lines of the upper and lower tubular heating elements 14 and 15 are both within the toasting region of the first central plane CP1. A horizontal plane in between of the upper and lower heating elements 14 and 15 is defined as the second central plane CP2. The left tubular heating element 12 is set on the left side of the left toasting chamber 11a, while the right tubular heating element 13 is set on the right side of the right toasting chamber 11b. The central longitudinal lines of the left and right tubular heating elements 14 and 15 are within the second central plane CP2. Preferably, there are four tubular heating elements 12 to 14 in total, but more are possible. The horizontal distances from the left and right tubular heating elements 12 and 13 to the first central plane CP1 are equal. A left reflector 16 is disposed on the left side of the left tubular heating element 12, while a right reflector 17 is disposed on the right side of the right tubular heating element 13. The left reflector 16 and the right reflector 17 are symmetrical about the first central plane CP1, and both are drum-shaped or generally concave. The left and right reflectors 16 and 17 are both formed by several pieces of flat or bent sheets with different obliquity, i.e. at obtuse angles to each other and the first central plane CP1. The shapes of the reflectors 16, 17 and 23 to 25 are suitable for reflecting part of the thermal radiation from the heating elements 12 to 15 toward the surface of the food slice. The left and right reflectors 16 and 17 facing the tubular heating elements 12 and 13, respectively, each contains a first reflective planar surface 18 and a second reflective planar surface 19 joined or formed next to each other, which are located above the second central plane CP2, and contains a third reflective planar surface 21 and a fourth reflective planar surface 22 also joined or formed next to each other, which are located under the second central plane CP2. The first reflective planar surface 18 is disposed at an obtuse angle α1 to the vertical plane 20 of 150° to 165°, and the second reflective planar surface 19 is disposed at the angle α2 to the first reflective planar surface 18 of 150° to 165°. The third reflective planar surface 21 and the first reflective planar surface 18, the fourth reflective planar surface 22 and the second reflective planar surface 19 are symmetrical to the second central plane CP2 along the upward and downward direction. The toasting chambers 11a and 11b, the tubular heating elements 12 to 15, and the left and right reflectors 16 and 17 are all fixed at their ends respectively on the front sheet and the back sheet.

The electric toaster also comprises other necessary parts not shown, such as a lift mechanism, a switch means, a wiring board assembly, etc, which can be applied in many ways as the conventional electric toaster.

The tubular heating elements 12 to 15 can be quartz heating tubes, stainless steel heating tubes or halogen heating tubes. The heating tubes 12 to 15 are fixed at the front and back plates by use of ceramic insulating sleeves; and the height of the heating tubes 12 to 15 is a bit below a middle height of the toasting chambers 11a and 11b in order to compensate for the temperature influence when hot air rises.

An upper reflector 23 is disposed above the upper tubular heating element 14, and a lower reflector 24 is disposed below the lower tubular heating element 15. The shapes of the upper and lower reflectors 23, 24 are suitable for reflecting part of the thermal radiation from the upper and lower heating tubes 14 and 15 towards the surfaces of the food slices in opposite directions in both the left and right toasting chamber 11a and 11b. The upper reflector 23 and the lower reflector 24 can be formed by multiple segments of planar surfaces at obtuse angles joined together, wherein the multiple segments of planar surfaces are symmetrical to the first central plane CP1 and are designed with proper reflection angles according to desires. As illustrated in FIG. 1, the upper reflector 23 has a first reflective planar surface 231; the first reflective planar surface 231 and a vertical plane forms an angle β1 of 30° to 60°, while the lower reflector 24 has a second reflective planar surface 241; the lower reflective planar surface 241 and a vertical plane forms an angle β2 of 30° to 60°.

A middle reflector 25 is set between upper and lower tubular heating elements 14,15. The middle reflector 25 is of a diamond columnar shape symmetrical to the first central plane CP1.

The reflectors 16, 17 and 23 to 25 are made from a material with high surface reflection efficiency, such as stainless steel plate or aluminum plate, etc. so as to achieve desirable toasting results.

By increasing the number of heating tubes, which are disposed between the two toasting chambers 11a and 11b, the electric toaster of the present invention can achieve a sufficient total power, ensuring safety and a long lifetime. Moreover, the increased quantity of heating tubes leads to a more even application of radiation directly from the heating tubes onto the surfaces of the food being toasted, thereby enabling the toasting of food without excess shielding.

As the heat from the heating tubes 12 to 15 is relatively concentrated and the toasting surface of bread is relatively large, the heat from the heat tubes 12 to 15 is unevenly spread onto the surfaces of the bread. The part of the bread which is nearest to the heating tubes 12 to 15 gets more reflected heat than the parts which are farther away. The reflectors 16, 17 and 23 to 25 are used to reflect most of the un-reflected heat back onto the surface of the bread. The above-mentioned shapes of the reflectors 16, 17 and 23 to 25 are to compensate the uneven heat spread over the bread slice so as to get bread toasted evenly. Only when the reflected heat by the reflectors 16, 17 and 23 to 25 is not enough to compensate for the uneven heat spreading by direct radiation, are shielding plates used for even toasting.

For a 1400 W power electric toaster with two toasting chambers and four tubular heating elements, it is preferred to choose upper and lower tubular heating elements of 315 W power, and left and right tubular heating elements of 385 W power to achieve desirable toasting.

1.-17. (canceled)

18. An electric toaster comprising:
an outer housing with openings in the top;
a top cover;
a control device disposed on the outer housing;
a toasting region enclosed inside the outer housing comprising left and right toasting chambers for toasting slices of food, each toasting chamber having an opening, which conforms to one of the openings in the top of the outer housing, the toasting region is surrounded by a front plate, a back plate, a right and a left reflector, which are joined together;
upper, lower, left and right tubular heating elements disposed on both sides of the left and right toasting chambers; and
a bottom with the toasting region fixed thereto;
wherein a vertical plane which is parallel to a surface of the slices of food and which is in between the left and right toasting chambers is defined as a first central plane;
wherein the upper and lower tubular heating elements are disposed between the left and right toasting chambers, and central lines of the upper and lower tubular heating elements are both within the toasting region of the first central plane;
wherein a horizontal plane between of the upper and lower heating elements is defined as the second central plane;
wherein the left tubular heating element is disposed on a left side of the left toasting chamber, while the right tubular heating element is disposed on a right side of the right toasting chamber;
wherein central lines of said left and right tubular heating elements are within said second central plane;
wherein a horizontal distance from the left or right tubular heating element to the first central plane is equal;
wherein a left reflector is disposed on the left side of the left tubular heating element, while a right reflector is disposed on the right side of the right tubular heating element; the left reflector and the right reflector are symmetrical and concave;
wherein the left and right reflectors are defined by a plurality of surfaces at obtuse angles to each other; the shape of the left and right reflectors are suitable for reflecting part of the thermal radiation from the left and right heating elements toward the surfaces of the slices of food;
wherein each of said left and right reflectors contains a first reflective surface and a second reflective surface adjacent to each other which are located above the second central plane, and contains a third reflective surface and a fourth reflective surface also adjacent to each other which are located under the second central plane;
wherein the first reflective surface is disposed to the vertical plane at an angle α1 of 150° to 165°, and the second reflective surface is disposed to the first reflective surface at an angle α2 of 150° to 165°; and
wherein the third reflective surface and the first reflective surface, and the fourth reflective surface and the second reflective surface are symmetrical to the second central plane.

19. The electric toaster according to claim 18, wherein said left and right tubular heating elements are selected from the group consisting of quartz heating tubes, stainless steel heating tubes and halogen heating tubes.

20. The electric toaster according to claim 18, wherein said left and right tubular heating elements are fixed at the front and back plates by use of ceramic insulating sleeves; and wherein the left and right tubular heating elements are positioned below the middle of the left and right toasting chambers to compensate for rising heat.

21. The electric toaster according to claim 20, further comprising:
an upper reflector disposed above the upper tubular heating element, and a lower reflector disposed below the lower tubular heating element;
wherein said upper and lower reflectors are shaped for reflecting part of the thermal radiation from the upper and lower tubular heating elements towards the surfaces of the slices of food in both the left and right toasting chambers.

22. The electric toaster according to claim 21, wherein the upper reflector and the lower reflector are formed by multiple surfaces at obtuse angles to each other, wherein said multiple surfaces are symmetrical to the first central plane.

23. The electric toaster according to any one of claims 18, wherein said upper reflector has a first reflective planar surface;
wherein the first reflective planar surface and a vertical plane forms an angle β1 of 30° to 60°, while the lower reflector has a second reflective planar surface; and
wherein the second planar reflective surface and the vertical plane forms an angle β2 of 30° to 60°.

24. The electric toaster according to claim 21, further comprising a middle reflector set between upper and lower tubular heating elements, the middle reflector having a diamond columnar shape symmetrical to the first central plane.

25. The electric toaster according to claim 24, wherein said middle reflector is made from a material with high surface reflection efficiency selected from the group consisting of stainless steel plate and aluminum plate.

26. The electric toaster according to claim 21, wherein said upper and lower reflectors are made from a material with high surface reflection efficiency selected from the group consisting of stainless steel plate and aluminum plate.

27. The electric toaster according to any one of claims 21, wherein said left and right reflectors are made from a material with high surface reflection efficiency selected from the group consisting of stainless steel plate and aluminum plate.

28. The electric toaster according to claim 27, wherein said upper and lower tubular heating elements are selected from the group consisting of quartz heating tubes, stainless steel heating tubes and halogen heating tubes.

29. The electric toaster according to claim 28, wherein said left and right tubular heating elements are fixed at the front and back plates by use of ceramic insulating sleeves; and the height of the left and right tubular heating elements is below a middle height of the left and right toasting chambers.

30. The electric toaster according to claim 18, further comprising:
an upper reflector disposed above the upper tubular heating element, and a lower reflector disposed below the lower tubular heating element;
wherein said upper and lower reflectors are shaped for reflecting part of the thermal radiation from the upper and lower tubular heating elements towards the surfaces of the slices of food in both the left and right toasting chambers.

31. The electric toaster according to claim 30, wherein the upper reflector and the lower reflector are formed by multiple surfaces at obtuse angles to each other, wherein said multiple surfaces are symmetrical to the first central plane.

32. The electric toaster according to claim 31, wherein said upper reflector has a first reflection planar surface; the first reflection planar surface and a vertical plane forms an angle β1 of 30° to 60°, while the lower reflector has a second reflection planar surface; the second planar reflection surface and the vertical plane forms an angle β2 of 30° to 60°.

33. The electric toaster according to claim 30, further comprising a middle reflector set between upper and lower tubular heating elements, the middle reflector having a diamond columnar shape symmetrical to the first central plane.

34. The electric toaster according to claim 33, wherein said middle reflector is made from a material with high surface reflection efficiency selected from the group consisting of stainless steel plate and aluminum plate.
